(19) United States
(12) Patent Application Publication
(10) Pub. No.: US 2026/0145071 A1
(43) Pub. Date: May 28, 2026

(54) NON-TRANSITORY COMPUTER-READABLE MEDIUM, INFORMATION PROCESSING SYSTEM, AND COMPUTER-IMPLEMENTED METHOD

(71) Applicant: Nintendo Co., Ltd., Kyoto (JP)

(72) Inventor: Wataru HINOSHITA, Kyoto (JP)

(21) Appl. No.: 19/390,217

(22) Filed: Nov. 14, 2025

(30) Foreign Application Priority Data
Nov. 28, 2024 (JP) 2024-207239

(51) Int. Cl. A63F 13/56; A63F 13/5378; A63F 13/577; A63F 13/803

(52) U.S. Cl. CPC A63F 13/56; A63F 13/5378; A63F 13/577; A63F 13/803

(57) ABSTRACT

In one example of a game system according to the exemplary embodiment, a session participation process including starting or joining up with a multiplayer session is performed in a period until a race start condition is satisfied, movement control is performed for a player object on a field, based on an operation input, and movement control is performed for another player object, based on position information on the other player object, which is acquired based on communication. If a race start condition is satisfied, a competitive racing game is started, movement control is performed for a player object on the field, based on an operation input, and movement control is performed for another player object, based on position information on the other player object, which is acquired based on communication.

### CROSS REFERENCE TO RELATED APPLICATION

This application claims priority to Japanese Patent Application No. 2024-207239, filed on Nov. 28, 2024, the entire contents of which are incorporated herein by reference.

### FIELD

The technique shown here relates to a non-transitory computer-readable medium having stored therein a game program, an information processing system, a computer-implemented method, and an information processing apparatus that enable execution of a racing game.

### BACKGROUND AND SUMMARY

Conventionally, there has been a system that performs a racing game using a plurality of player objects.

However, in such conventional games, a player cannot play a game with another player in a period until a racing game is started.

The exemplary embodiment discloses a game program, an information processing system, a computer-implemented method, and an information processing apparatus that enable a player to play a game with another player in a period until a racing game is started.

The exemplary embodiment adopts the following configurations.

### First Configuration

A game program according to a first configuration is one or more non-transitory computer-readable media having stored therein instructions that, when executed, cause one or more processors to execute game processing comprising, regarding an online multiplayer competitive racing game:
in a period until a race start condition is satisfied,
   performing a session participation process including starting or joining up with a multiplayer session, based on communication,
   performing movement control for a player object on a field in a virtual space, based on an operation input,
   transmitting position information on the player object, and
   performing, on the field, movement control for another player object included in a multiplayer session being participated in, based on position information on the other player which is acquired based on communication;
in a case where the race start condition is satisfied, starting the competitive racing game by players included in the multiplayer session; and
during the competitive racing game,
   in a course corresponding to the competitive racing game, among a plurality of courses set at respective places on the field,
      performing movement control for the player object, based on an operation input,
      transmitting position information on the player object, and
      controlling another player included in the multiplayer session being participated in, based on position information on the other player object which is acquired based on communication,
   thus performing the competitive racing game.

With the above configuration, in a period until a competitive racing game is started, a player object can be moved together with another player object on a field where a competitive racing game is performed.

### Second Configuration

In a second configuration based on the first configuration, the race start condition may include that a number of participants in the multiplayer session reaches a predetermined number. The game processing may further include, in the period until the race start condition is satisfied, performing movement control for the player object and the other player object, and continuously performing the session participation process until the number of participants in the multiplayer session reaches the predetermined number.

With the above configuration, in a period until the number of participants reaches a predetermined number, a player object can move together with another player object on a field.

### Third Configuration

In a third configuration based on the first configuration, the multiplayer session may be a session that allows joining up with a session including the other player performing a race, through the session participation process, and the race start condition may include at least that the other player participating in the multiplayer session is not performing a race.

With the above configuration, another player object performing a race is subjected to movement control on a field, based on position information. Thus, a player who has joined up with the session can watch the race during a period until the race is ended.

### Fourth Configuration

In a fourth configuration based on the third configuration, the game processing may further include, in the period until the race start condition is satisfied, setting, for the other player object performing a race, a display manner different from that for the other player object not performing a race.

With the above configuration, another player object performing a race and another player object not performing a race can be displayed in different display manners, and a player can easily discriminate these player objects from each other.

### Fifth Configuration

In a fifth configuration based on the fourth configuration, the different display manner may be such a display manner that transparency is increased.

With the above configuration, another player object performing a race can be displayed with transparency thereof increased.

### Sixth Configuration

In a sixth configuration based on the fourth or fifth configuration, the different display manner may be such a display manner that a UI indicating a state of performing a race is added. The game processing may further include, in the period until the race start condition is satisfied, setting, for the other player object not performing the race, a display manner in which a UI indicating a predetermined state is added, in a case where the other player object is in the predetermined state.

With the above configuration, the state of another player object not performing a race can be displayed so as to be easily recognized by a player.

### Seventh Configuration

In a seventh configuration based on any one of the third to sixth configurations, the game processing may further include, in the period until the race start condition is satisfied, without performing collision determination between the other player object performing a race and the player object, performing collision determination between the other player object not performing a race and the player object, and performing a collision process based on the collision determination.

With the above configuration, a player can watch the race without disturbing a race being executed by other players.

### Eighth Configuration

In an eighth configuration based on any one of the first to seventh configurations, the game processing may further include: rendering the field in a display manner based on an environment being set, among a plurality of kinds of environments to be set for the virtual space; and in a case of having participating in the multiplayer session through the session participation process, changing the environment of the virtual space to the environment set in the multiplayer session participated in.

With the above configuration, at the time of participating in a game session, the display manner can be changed to a display manner according to an environment set for the game session.

### Ninth Configuration

In a ninth configuration based on any one of the first to eighth configurations, the game processing may further include: in accordance with an instruction based on an operation input, presenting a map UI representing a map on the field and including at least a UI indicating a position of the player object on the field, a UI indicating a position of the other player object on the field, and movement destination UIs indicating at least a plurality of movement destination points set on the field; and in a case where, on the map UI, one of the movement destination UIs is designated based on an operation input, changing a position of the player object to a position on the field corresponding to the movement destination point, and restarting movement control from the changed position.

With the above configuration, it is possible to move a player object using the map UI.

Another configuration may be an information processing system, an information processing apparatus, or a computer-implemented method for executing the game.

According to the exemplary embodiment, in a period until a competitive racing game is started, it is possible to move a player object together with another player object on a field where a competitive racing game is performed.

These and other features, aspects, and advantages of the subject matter described herein will become more apparent from the following detailed description when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram showing an example of a field in a virtual space;

FIG. 4 is an example non-limiting diagram showing an example of a route RA1 set in a base area A1;

FIG. 5 is an example non-limiting diagram showing the outline of a process in a case where a competitive racing game in the exemplary embodiment is performed;

FIG. 6 is an example non-limiting diagram showing an example of a game image displayed on a screen of a game system 1a, which is an example of a game image during free run;

FIG. 7 is an example non-limiting diagram showing examples of game images during free run, which are examples of game images before and after the game system 1a joins up with a game session GS;

FIG. 8 is an example non-limiting diagram showing an example of a game image when a map UI is activated during free run of a player object PA after the game system 1a joins up with the game session GS;

FIG. 9 is an example non-limiting diagram showing a scene in which a position on the field is designated using a cursor on the map UI;

FIG. 10 is an example non-limiting diagram showing an example of a game image after the player object PA during free run has moved to a location where a player object PC during a competitive racing game is present;

FIG. 11 is an example non-limiting diagram showing an example of a game image when a player object PD that has reached a goal is performing free run;

FIG. 12 is an example non-limiting diagram showing an example of a game image when the next competitive racing game is being performed;

FIG. 13 is an example non-limiting diagram showing an example of various data stored in the game system 1a;

FIG. 14 is an example non-limiting flowchart showing an example of game processing for performing an online multiplayer competitive racing game;

FIG. 15 is an example non-limiting flowchart showing an example of a participation process started in step S11;

FIG. 16 is an example non-limiting flowchart showing an example of a first free run process in step S12;

FIG. 17 is an example non-limiting flowchart showing an example of a map UI process in step S27;

FIG. 18 is an example non-limiting flowchart showing an example of a second free run process in step S13;

FIG. 19 is an example non-limiting flowchart showing an example of a competitive racing game process in step S14; and

FIG. 20 is an example non-limiting flowchart showing an example of a server process performed in a server.

### DETAILED DESCRIPTION OF NON-LIMITING EXAMPLE EMBODIMENTS

### Game System Configuration

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of direction buttons 30 including an up button, a down button, a right button, and a left button, a plurality of buttons (A button, B button, X button, Y button, L button, R button, etc.), a left analog stick 31, and a right analog stick 35.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

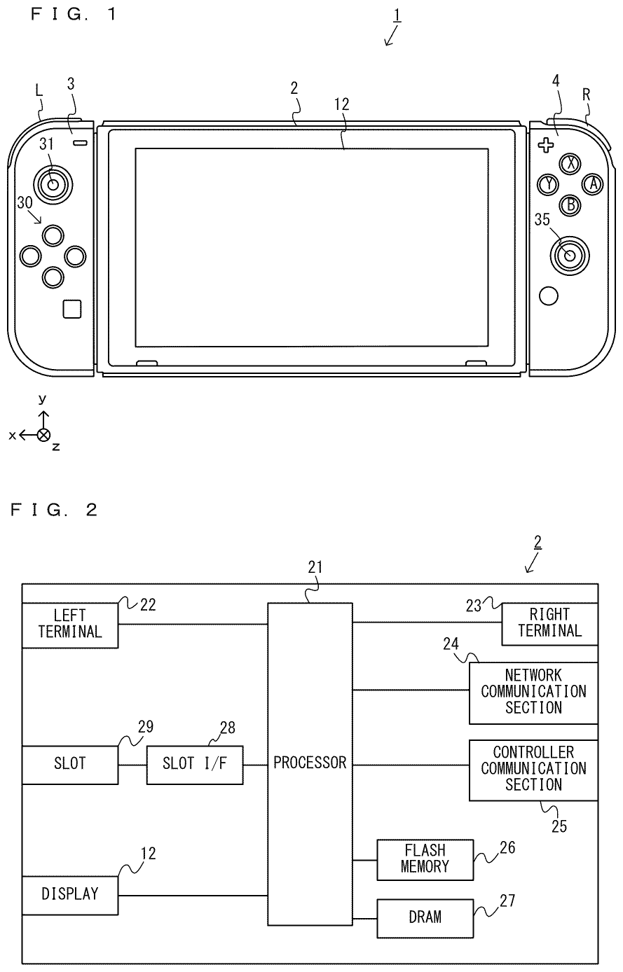

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### Outline of Game

Next, the outline of a game executed in game system 1 will be described. The game program in the exemplary embodiment enables execution of a competitive multiplayer game performed by a plurality of players. Specifically, a multiplayer game in the exemplary embodiment is a competitive racing game in which a plurality of player objects operated by a plurality of players are moved on a field in a virtual space (game space). The player object includes a character and a vehicle object, for example. The vehicle object may be an object such as a car or a bike, which travels on a ground, or an object such as an aircraft, which moves in air, for example. The player object may be composed of only a character or may be composed of only a vehicle object.

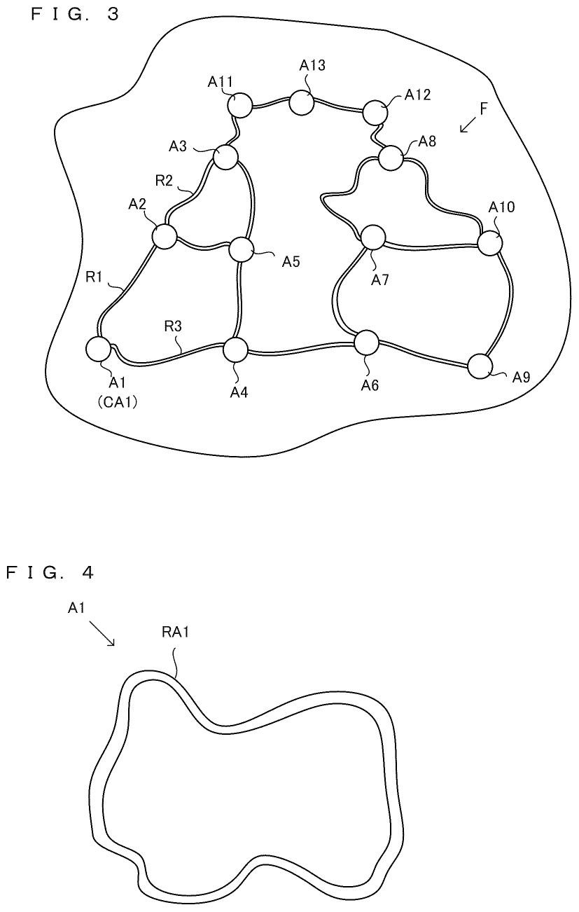

First, a field in a virtual space will be described. FIG. 3 shows an example of the field in the virtual space.

As shown in FIG. 3, a plurality of base areas A (FIG. 3, A1 to A13) are set on a field F in a virtual space. In FIG. 3, each base area A is shown as a circle, and in each base area A, a route R is set. The route R is a kind of terrain and is a region where the player object can easily travel. For example, the route R is a road. On the field, various regions are set, other than the route R. For example, regions of sand, grass and a water surface are set. The regions (regions of sand, grass, and a water surface) other than the route R are regions where it is difficult for the player object to travel.

FIG. 4 shows an example of a route RA1 set in a base area A1.

As shown in FIG. 4, the route RA1 is provided in the base area A1. The route RA1 is a region where the player object can move. In a case where a competitive racing game is performed by a plurality of player objects, for example, a course along the route RA1 is set. When the competitive racing game is started, the plurality of player objects move along the route RA1 and go around a predetermined number of laps along the route RA1 to reach a goal point. When all the player objects participating in the competitive racing game have reached the goal point, the competitive racing game is ended.

As shown in FIG. 3, routes R (e.g., routes R1 to R3) connecting the base areas A are provided on the field F. In a case where a competitive racing game is performed by a plurality of player objects, for example, a course along the route R1 may be set. Hereinafter, a route provided in a site and a route provided between sites are collectively referred to as “routes R”.

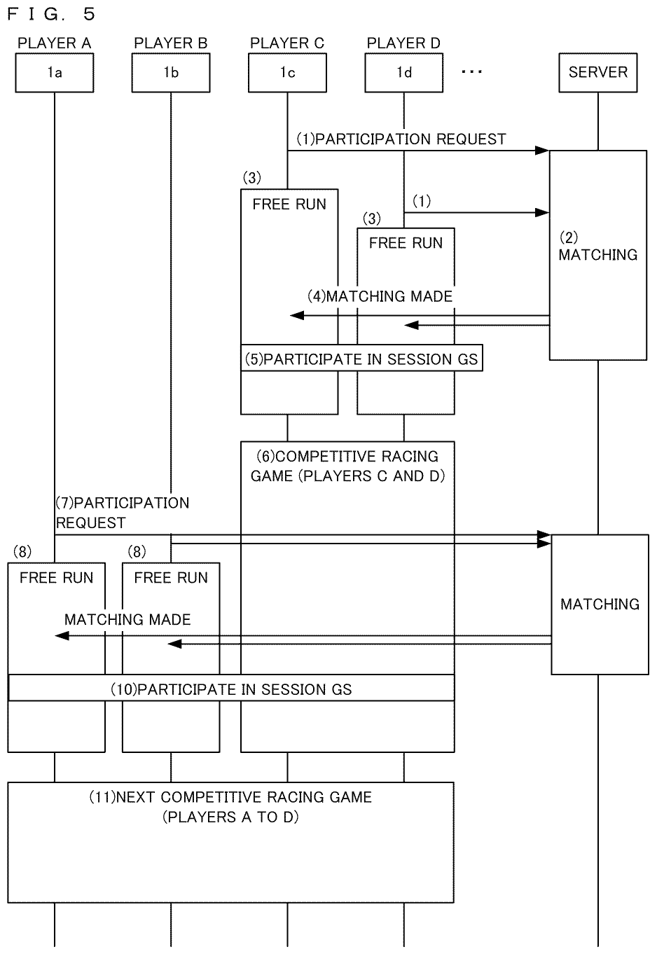

FIG. 5 shows the outline of a process in a case where the competitive racing game in the exemplary embodiment is performed.

A plurality of game systems 1 (main body apparatuses 2) corresponding to a plurality of players are connected to a network (e.g., the Internet). For example, a game system 1a corresponding to a player A, a game system 1b corresponding to a player B, a game system 1c corresponding to a player C, and a game system 1d corresponding to a player D, are connected to the Internet. A server is provided on the Internet. Other than these, multiple game systems 1 are connected to the Internet and participate in the competitive racing game.

As shown in FIG. 5, for example, when the player C gives an instruction to participate in an online multiplayer competitive racing game using the game system 1c, the game system 1c transmits a participation request for participating in or join up with a game session, to the server (1). Similarly, the game system 1d also transmits a participation request to the server (1). The server performs a matching process of matching a plurality of players in accordance with the requests (2). The server matches a plurality of players, based on game records, levels (skills), and the like of the players, for example.

The game system 1c that has transmitted the participation request causes a player object PC to freely travel on a field, based on an operation by the player C, during a period until the matching process by the server is completed and a competitive racing game is started (3). Here, causing the player object to freely travel on the field is referred to as “free run”. The player object during free run can move through any positions on the field. For example, the player object PC can move along the route RA1 set in the base area A1, during free run. In addition, the player object PC can move along the route R1 connecting the base area A1 and a base area A2, during free run. In addition, the player object PC can move in a region different from the route R, during free run. Similarly, also in the game system 1d, free run in which the player object PD is caused to freely travel on the field is performed based on an operation by the player D (3).

When matching is established in the matching process, the server generates a game session GS and transmits a notification that matching is established, to the game system 1 of each player (4). For example, when the number of players that satisfy a condition has reached a predetermined number (e.g., two or more), the server generates a game session GS. Here, it is assumed that the server has matched the player C and the player D. Specifically, the server transmits session data including an ID for identifying the game session GS, to the game systems 1c and 1d. The game systems 1c and 1d receive the session data and establish communication with each other. Thus, the game systems 1c and 1d start the game session GS (participate in the game session GS) (5). At the same time, the server receives participation requests from a plurality of other game systems 1, matches a plurality of other players, and generates a game session other than the game session GS. The server manages a plurality of game sessions at the same time.

When the game systems 1c and 1d have participated in the game session GS, thereafter, the game systems 1c and 1d communicate with each other to exchange information about each of the player objects PC and PD (e.g., information about a position, an orientation, a movement direction, a speed, and the like).

After the game systems 1c and 1d have participated in the game session GS, free run by each of the player objects PC and PD is performed also during a period until the competitive racing game is started.

Specifically, before participating in the game session GS, each of the game systems 1c and 1d sets a virtual space on the own system and allows only the player object corresponding to the own system to freely travel in the virtual space, based on an operation by the player. During this period, the game system 1 may control, in addition to the player object, a non-player object which is controlled by the processor 21, in the virtual space. Then, when the game systems 1c and 1d have participated in the game session GS, the player objects PC and PD are placed in the same virtual space and perform free run. For example, in a case where the player object PC and the player object PD are at the same location on the field, the player object PC and the player object PD are displayed on the screen of the game system 1c.

When time has further passed since the game systems 1c and 1d participated in the game session GS, free run by each of the player objects PC and PD is ended. For example, when the number of players that satisfy a condition has reached a predetermined number and communication is established between a predetermined number of game systems 1 is established so that a race start condition is satisfied, free run by each player object is ended. Alternatively, when a predetermined time has passed since the game systems 1c and 1d participated in the game session GS, a race start condition may be satisfied and free run may be ended. Then, in one of a plurality of courses set on the field, a competitive racing game by the players C and D is started (6). In the competitive racing game, the player objects PC and PD move along the course, based on operations by the players C and D. When the player objects PC and PD have reached a goal point set on the course, the competitive racing game on the course is ended.

Here, during execution of the competitive racing game by the players C and D, if the player A gives an instruction to participate in a competitive racing game using the game system 1a, the game system 1a transmits a participation request to the server (7). The game system 1a that has transmitted the participation request executes free run in which the player object PA is caused to freely travel on the field, based on an operation by the player A, during a period until a matching process by the server is completed and a competitive racing game is started (8).

Similarly, the game system 1b also transmits a participation request to the server, based on an instruction by the player B. During a period until a matching process by the server is completed and a competitive racing game is started, the game system 1b executes free run in which the player object PB is caused to freely move in the virtual space, based on an operation by the player B.

Here, it is assumed that the server performs a matching process, based on participation requests from the game systems 1a and 1b, and determines to cause the players A and B to join up with the game session GS in which the players C and D are participating, as a result of the matching process. In this case, the server notifies the game systems 1a and 1b that matching is established (9). Specifically, the server transmits session data including an ID for identifying the game session GS in which the players C and D are participating, to the game systems 1a and 1b.

Then, the game systems 1a and 1b join up with (participate in) the game session GS (10). Specifically, the game systems 1a and 1b acquire the ID for identifying the game session GS from the server and establish communication among the game systems 1a to 1d. Thus, the game systems 1a to 1d participate in the same game session GS. Thereafter, the game system 1a receives position information and the like of the player objects PB to PD from the game systems 1b to 1d. When the game systems 1a to 1d participate in the game session GS, the player objects PA to PD become present in the same virtual space. For example, in a case where the player object PA and the player object PB are at the same location on the field, the player object PA and the player object PB are displayed on the screen of the game system 1a. In a case where the player object PA and the player object PC are at the same location on the field, the player object PA and the player object PC are displayed on the screen of the game system 1a.

After the game systems 1a and 1b have participated in the game session GS, the player objects PA and PB perform free run also during a period until the next competitive racing game is started. For example, the player A can move the player object PA to a place where a competitive racing game by the player objects PC and PD is being performed. Even when the player object PA has moved to the place where the competitive racing game by the player objects PC and PD is being performed, the player object PA performs free run without participating in the competitive racing game performed by the player objects PC and PD. Thus, the player A can cause the player object PA to travel alongside the player objects PC and PD performing the competitive racing game, and can watch the competitive racing game.

When the competitive racing game by the player objects PC and PD is ended, free run of the player objects PA and PB is ended. Then, the next competitive racing game by the player objects PA to PD is started (11).

Next, an example of a game image displayed on a screen (a screen of the display 12 or another display device) of the game system 1a when a competitive racing game is performed from the free run described with reference to FIG. 5 will be described.

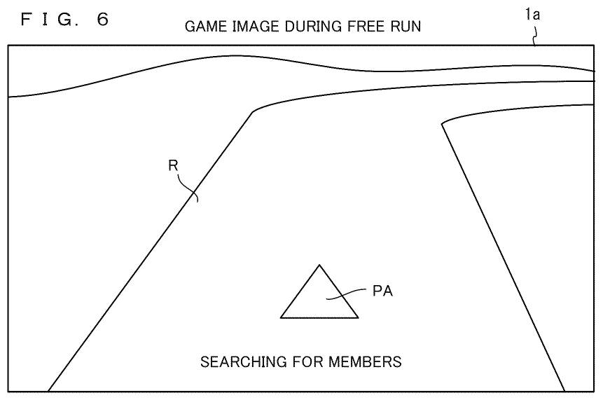

FIG. 6 shows an example of a game image displayed on the screen of the game system 1a, which is an example of a game image during free run. In FIG. 6, an example of a game image after the player A gives an instruction to participate in an online multiplayer competitive racing game using the game system 1a and before the game system 1a joins up with the game session GS, is shown.

As shown in FIG. 6, a scene in which the player object PA is traveling on the route R is displayed. On the screen, a text “SEARCHING FOR MEMBERS” is displayed, for example. When free run is started, the player object PA is placed at a predetermined position on a field. For example, when free run is started, the player object PA may be placed at a randomly determined position, or may be placed at a position designated by the player A. The player A can move the player object PA through any positions on the field, based on an operation on the controller. For example, the player A can move the player object PA along the route RA1 in the base area A1 set on the field. In addition, the player A can move the player object PA in a region (grass, sand, a water surface, etc.) other than the route R. In addition, the player A can cause the map UI described later to be displayed, move the player object PA instantaneously to a position designated on the map UI, and cause the player object PA to travel in the place to which the player object PA has been moved.

While the game image shown in FIG. 6 is being displayed, another player object corresponding to another player is not present in a virtual space defined in the game system 1a. During this period, a non-player object may be subjected to movement control in the virtual space.

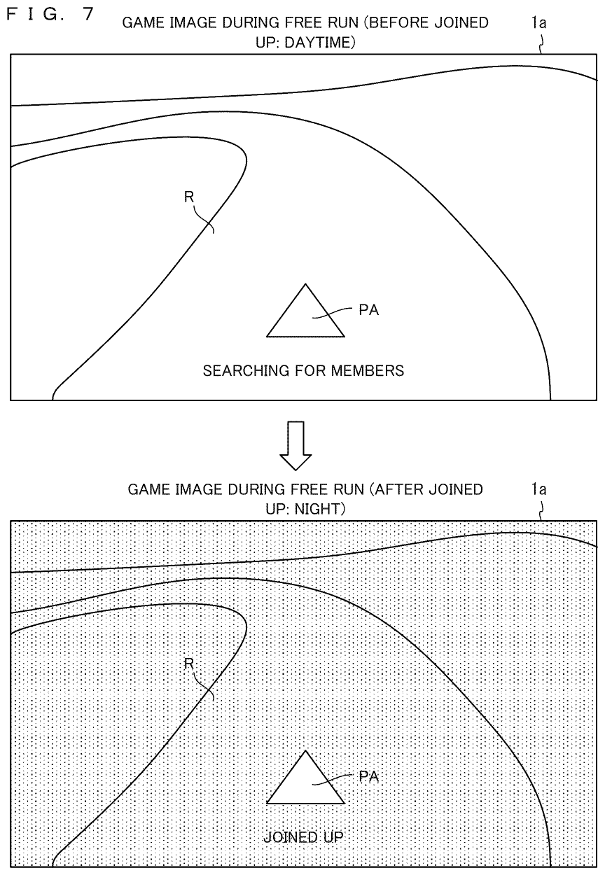

FIG. 7 shows game images during free run, which are examples of game images before and after the game system 1a joins up with the game session GS.

As shown in an upper diagram in FIG. 7, before the game system 1a joins up with the game session GS, the player object PA is traveling in a predetermined place on the field. In a case where a matching process by the server is performed and the game system 1a joins up with the game session GS as a result of the matching process, a game image as shown in a lower diagram in FIG. 7 is displayed. For example, a text “JOINED UP” is displayed on the screen. Also after the game system 1a has joined up with the game session GS, the player object PA is traveling in a predetermined place on the field.

In the virtual space, an environment according to the time is set. Examples of environments include morning, noon, evening, and night. The display manner of the virtual space differs in accordance with the environment. When the game system 1a participates in the game session GS, the environment of the virtual space changes to the environment set for the game session GS, and the display manner of the virtual space changes. For example, in a case where the time in the game system 1a is noon, before the game system 1a participates in the game session GS, the environment of the virtual space is also noon, so that a game image that is bright in whole is displayed (upper diagram in FIG. 7). In a case where the game system 1a participates in the game session GS, if the environment set for the game session GS is night, the game image changes to a game image that is dark in whole (lower diagram in FIG. 7).

When the game system 1a joins up with the game session GS (i.e., when changing from the upper diagram to the lower diagram in FIG. 7), a switchover image for switching the screen is displayed. For example, as a switchover image, such an image that the game image in the upper diagram in FIG. 7 is faded out may be displayed. The screen may be instantaneously changed from the upper diagram to the lower diagram in FIG. 7 without displaying such a switchover image. In another exemplary embodiment, the display manner of the virtual space may not be changed between before and after joining up with the game session GS.

When the game system 1a has joined up with the game session GS, in the virtual space, the player objects PC and PD are present in addition to the player object PA. When the game system 1b has joined up with the game session GS, the player object PB is also present in the same virtual space. In the lower drawing in FIG. 7, another player object corresponding to another player is not present around the player object PA, and therefore only the player object PA is displayed. In a case where another player object is present around the player object PA, the other player object is displayed on the screen of the game system 1a. For example, in a case where the player A causes the player object PA to travel and thus moves the player object PA to the place where the player objects PC and PD are present, the player objects PC and PD are displayed on the screen of the game system 1a. In addition, by performing a predetermined operation input during free run shown in FIG. 7, the player A can activate the map UI and warp the player object PA to a position designated on the map UI.

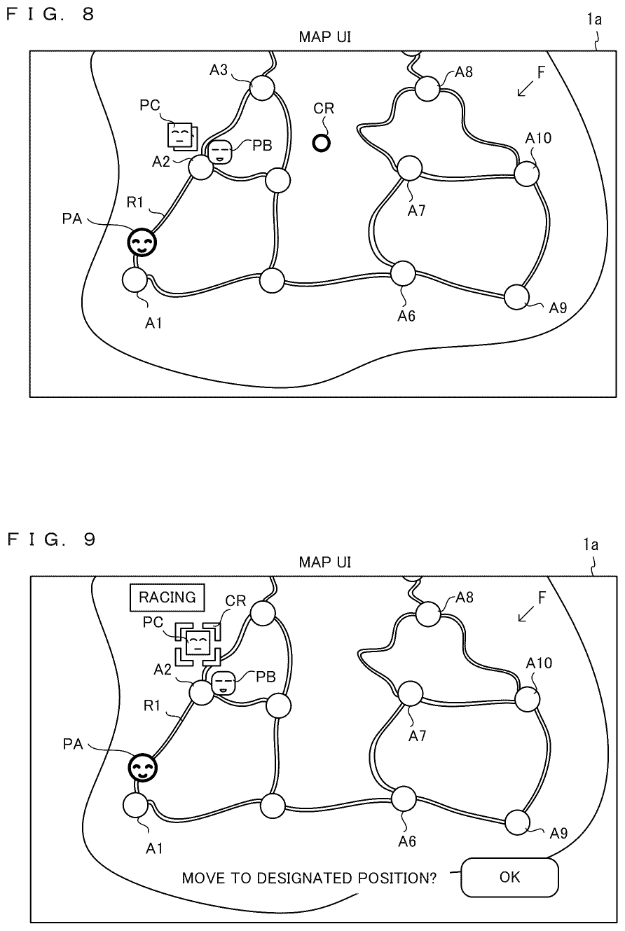

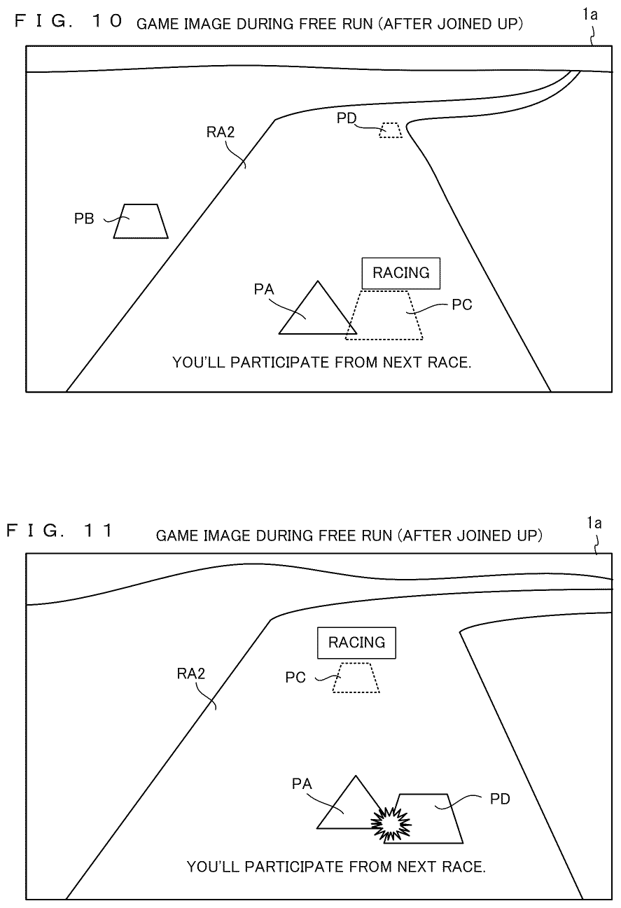

FIG. 8 shows an example of a game image when the map UI is activated during free run of the player object PA after the game system 1a has joined up with the game session GS. FIG. 9 shows a scene in which a position on the field is designated using a cursor on the map UI.

As shown in FIG. 8, on the map UI, a map image representing at least a part of the field F is displayed. On the map UI, an icon of the player object PA is displayed, and the position of the icon indicates the present position of the player object PA on the field. In FIG. 8, the icon of the player object PA is located on the route R1 connecting the base area A1 and the base area A2, and indicates that the player object PA is located on the route R1. In addition, the icon of another player object operated by another player is displayed on the map UI. For example, in FIG. 8, the icon of the player object PC operated by the player C is displayed near the base area A2. In addition, the icon of the player object PD is displayed in an overlapping manner on the icon of the player object PC. This indicates that the player object PC and the player object PD are located in the base area A2. On the map UI, the icon of the player object PB performing free run is also displayed. In addition, a cursor CR for the player A to designate a position is displayed on the map UI.

As shown in FIG. 9, when the player A designates the icon of the player object PC performing a competitive racing game using the cursor CR on the map UI, a text “RACING” is displayed and an “OK” button is displayed. In this state, when the player A presses the OK button (e.g., presses the A button), the player object PA warps to the place where the player object PC is present.

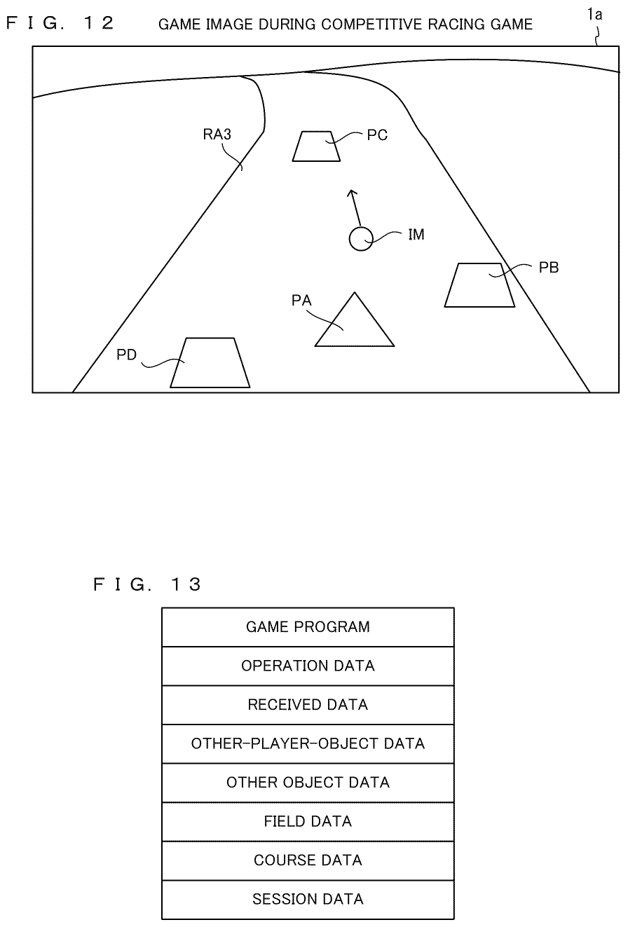

FIG. 10 shows an example of a game image after the player object PA performing free run has moved to the place where the player object PC performing a competitive racing game is present.

As shown in FIG. 10, on the screen of the game system 1a, the player object PA, the player object PC, and the player object PD are displayed. In a case where the player object PB is located near the player object PA, the player object PB is also displayed. Here, the player objects PC and PD are performing a competitive racing game, and the player object PB is performing free run. The player objects PC and PD performing the competitive racing game are displayed in a display manner different from that of the player object PA performing free run. For example, the player objects PC and PD performing the competitive racing game are displayed translucently, and the player object PA performing free run is displayed opaquely (in a normal manner). The player object PB performing free run is also displayed opaquely as with the player object PA.

The player objects PC and PD move along a route RA2 set in the base area A2, based on operations by the players C and D, respectively. Specifically, the game system 1a receives position information on the player objects PC and PD from the game systems 1c and 1d, and performs movement control for the player objects PC and PD, based on the position information. The player objects PC and PD performing the competitive racing game interact with each other. As used herein, interaction includes a case where player objects collide with each other and a case where one player object is influenced by an item used by another player object.

For example, in a case where collision determination is performed based on the position of the player object PC and the position of the player object PD and it is determined that they collide with each other, the player object PC and the player object PD perform behaviors according to the collision. For example, in a case where the player object PC and the player object PD collide with each other, the player object PC and the player object PD are overturned, reduced in speed, or temporarily stopped. The behaviors (overturn, speed reduction, temporary stoppage, etc.) of the player object PC and the player object PD according to the collision are displayed on the screen of the game system 1a.

By contacting with an item acquisition object placed in the virtual space during the competitive racing game, each of the player objects PC and PD can acquire an item and attack another player object performing the competitive racing game, using the acquired item. For example, the player object PC can acquire an item and launch the item in the virtual space. If the item launched by the player object PC hits the player object PD, the player object PD is overturned, reduced in speed, or temporarily stopped. Information about items possessed by the player objects PC and PD performing the competitive racing game and items launched by the player objects PC and PD is not shared with the game system 1a corresponding to the player object PA performing free run. Thus, the item possessed by the player object PC and the item launched by the player object PC are not displayed on the screen of the game system 1a. However, the behavior (overturn, speed reduction, temporary stoppage, etc.) of the player object PD when the item launched by the player object PC hits the player object PD is displayed on the screen of the game system 1a. On the screen of the game system 1a, objects (e.g., objects defining the course, etc.) that appear only during the competitive racing game are not displayed.

Meanwhile, on the screens of the game systems 1c and 1d corresponding to the player objects PC and PD performing the competitive racing game, for example, the item possessed by the player object PC and the item launched by the player object PC are displayed.

In another exemplary embodiment, information about the item possessed by the player object PC and the item launched by the player object PC during the competitive racing game may be shared with the game system 1a, and the items may be displayed also on the screen of the game system 1a.

The player object PA performs free run without participating in the competitive racing game performed by the player objects PC and PD. The player object PA can travel alongside the player objects PC and PD, and can travel in a direction opposite to the player objects PC and PD, for example. The player object PA is not seen from the players C and D. That is, the player object PA is not displayed on the screens of the game systems 1c and 1d corresponding to the players C and D.

The player object PA performing free run does not interact with the player objects PC and PD performing the competitive racing game. For example, as shown in FIG. 10, even when the player object PA and the player object PC overlap each other, the player object PA and the player object PC do not collide with each other. Specifically, collision determination between the player object PA and each of the player objects PC and PD is not performed.

By contacting with an item acquisition object during free run, the player object PA can acquire an item. Although the player object PA can launch the acquired item in the virtual space, the item launched by the player object PA does not hit the player objects PC and PD. That is, collision determination is not performed between the item launched by the player object performing free run, and the player objects performing the competitive racing game.

On the other hand, the player object PA performing free run interacts with the player object PB which is also performing free run. Specifically, collision determination is performed between the player object PA and the player object PB. In addition, collision determination is performed between an item launched by one player object performing free run, and another player object performing free run. For example, in a case where the player object PA has launched an item, the item can hit the player object PB. In this case, the player object PB is overturned, reduced in speed, or temporarily stopped.

As shown in FIG. 10, a UI indicating a state of performing a competitive racing game is displayed near the player object PC. For example, a text “RACING” may be displayed near the player object PC. The same applies to the player object PD. On the screen of the game system 1a, a text “YOU'LL PARTICIPATE FROM NEXT RACE.” is displayed.

States of player objects include a state of watching, other than the state of performing a competitive racing game. The state of watching is a state after a player object has performed a competitive racing game and is defeated, and is a state in which the player is not performing a competitive racing game subsequently performed by other players and is watching the subsequently performed competitive racing game. A text “WATCHING” is displayed near a player object that is in a state of watching. The player object performing watching is displayed translucently. The player object PA performing free run and the player object performing watching do not interact with each other. Therefore, the state of watching may be considered to be a part of the state of performing a competitive racing game.

States of player objects include a state of capturing. The state of capturing is a state in which a player is not performing a competitive racing game and is capturing a game image. A text “CAPTURING” is displayed near a player object that is in a state of capturing. The player object performing capturing is displayed opaquely. The player object PA performing free run and the player object performing capturing interact with each other. The state of capturing is a part of the state of performing free run.

When time has passed from the state shown in FIG. 10, for example, the player object PD reaches a goal. When the player object PD has reached the goal, the player object PD shifts from the state of performing the competitive racing game to a state of performing free run.

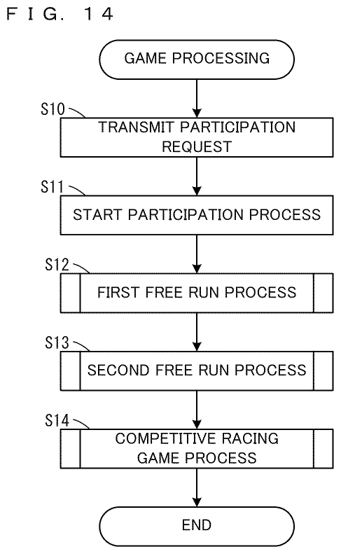

FIG. 11 shows an example of a game image when the player object PD has reached a goal and is performing free run.

As shown in FIG. 11, the player object PC has not reached the goal yet and is performing the competitive racing game, and therefore the player object PC is displayed translucently. On the other hand, the player object PD performing free run is displayed opaquely. The player object PA and the player object PD performing free run interact with each other. For example, in a case where the player object PA and the player object PD overlap each other, the player object PA and the player object PD collide with each other and perform behaviors according to the collision. For example, collision determination is performed between an item launched by the player object PA, and the player object PD, and if it is determined that they collide with each other, the player object PD performs a behavior according to the collision with the item.

When time has passed from the state shown in FIG. 11, all player objects performing the competitive racing game reach the goal and the competitive racing game is ended. When the competitive racing game is ended, a race start condition for the next competitive racing game is satisfied, so that the next competitive racing game is started.

FIG. 12 shows an example of a game image when the next competitive racing game is being performed.

As shown in FIG. 12, the next competitive racing game is performed by a plurality of player objects including the player objects PA to PD. The player objects PA to PD are displayed opaquely (in a normal manner) on the screen of the game system 1a. The player objects PA to PD performing the competitive racing game interact with each other. For example, collision determination is performed based on the position of the player object PA and the position of the player object PB, and if it is determined that they collide with each other, the player object PA is overturned, reduced in speed, or temporarily stopped. By contacting with an item acquisition object placed in the virtual space during the competitive racing game, the player object PA acquires an item. The player object PA can attack other player objects PB to PD, using the acquired item. For example, in a case where the player object PA launches an item IM in the virtual space and the item IM hits the player object PC, for example, the player object PC is overturned, reduced in speed, or temporarily stopped. An item launched by each of the other player objects PB to PD can hit the player object PA.

As described above, in the game in the exemplary embodiment, before an online multiplayer competitive racing game is started, a player can cause a player object to freely travel on a field. On the field, another player object operated by another player is moved. Thus, before a racing game is started, the player can move the player object together with the other player.

During free run, a player can move a player object on a course of a competitive racing game being performed by other players, and can cause the player object to travel on the course together with other player objects performing the competitive racing game. Thus, while watching the competitive racing game being performed by other players, the player can participate in the racing game in a pseudo manner, instead of merely watching the competitive racing game.

In the above description, it has been described that free run in which a player object is caused to freely travel on a field is performed before a competitive racing game is started. Without limitation to performing free run before a competitive racing game is started, a player can select free run on a game selection screen and freely move a player object on a field. For example, in a case where execution of the game program in the exemplary embodiment is started, a game selection screen is displayed, and a player can select and execute one of a plurality of games including an online multiplayer competitive racing game, free run, a single-player game, an offline multiplayer competitive racing game, and the like, on the game selection screen.

### Details of Game Processing

Next, the details of the game processing in the game system 1 will be described. Here, a case where the game system 1a joins up with the game session GS started by the game systems 1c and 1d as shown in FIG. 5 will be described as an example. First, data stored in the game system 1a will be described.

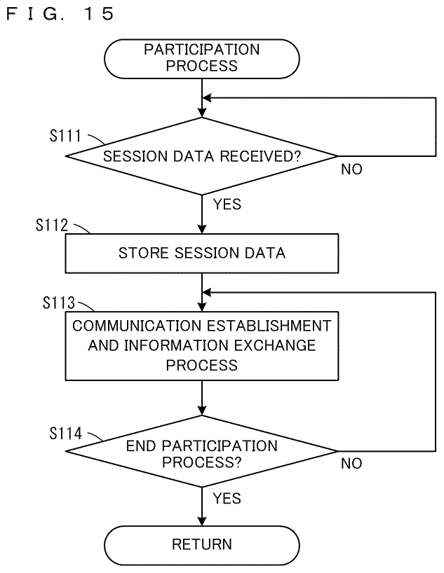

FIG. 13 shows an example of various data stored in the game system 1a. As shown in FIG. 13, a game program, operation data, received data, player object data, other-player-object data, other object data, field data, course data, and session data are stored in a memory (e.g., the DRAM 27, the storage medium attached to the slot 29, or the flash memory 26) of the game system 1a.

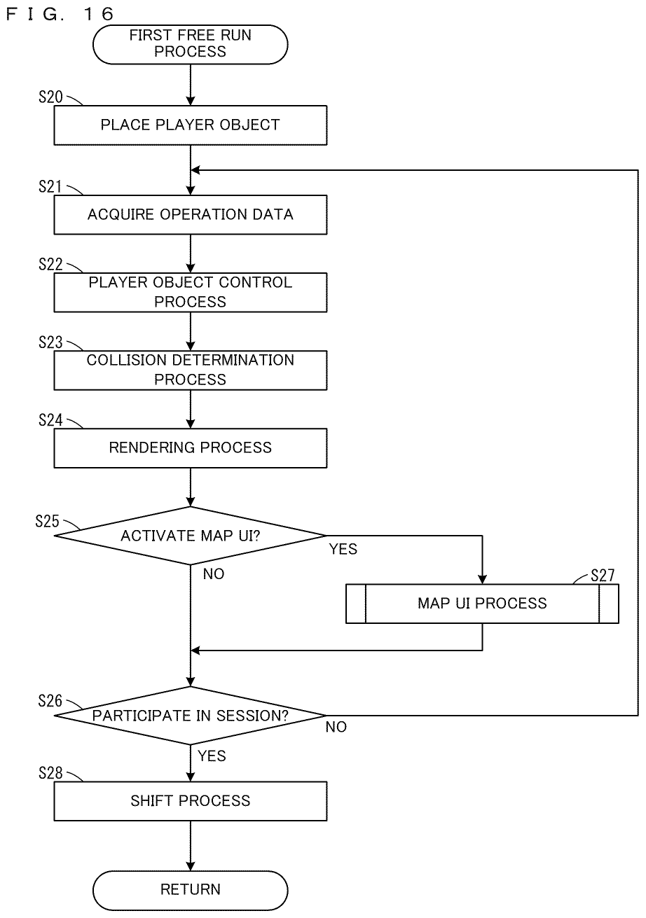

The game program is a program for executing processes regarding a game in the exemplary embodiment (processes shown in FIG. 14 to FIG. 19). The game program is stored in the storage medium attached to the slot 29 or the flash memory 26 in advance, and is loaded into the DRAM 27 when the racing game is executed.

The operation data is data according to operations on the controllers 3 and 4 of the game system 1a. The operation data is acquired at predetermined time intervals from the controllers 3 and 4.

The received data is data received from another game system 1 participating in the game session GS. The received data is received from another game system 1 at predetermined time intervals, for example. The received data includes data about a plurality of other player objects. Specifically, the received data includes data about the position, the orientation, the movement direction, the speed, and the like of each of other player objects.

The player object data is data about the player object PA operated by the player A. The player object data includes data representing the shape or the outer appearance of the player object PA, and data representing the position, the orientation, the movement direction, the speed, and the like of the player object PA, for example. In addition, the player object data includes data about an item possessed by the player object PA.

The other-player-object data includes data about other player objects (PB, PC, PD, etc.) operated by other players. The other-player-object data includes data about each of a plurality of other player objects. Specifically, the other-player-object data includes data representing the shape and the outer appearance of each of other player objects, and data indicating the position, the orientation, the movement direction, the speed, and the like of each of other player objects. In addition, the other-player-object data includes data indicating the state of each of other player objects. States of other player objects include a state of performing a competitive racing game, a state of watching, a state of capturing, a state of performing free run, and the like. In a case where a competitive racing game is being performed between the player object PA and another player object, the other-player-object data includes data about an item possessed by the other player object.

The other object data is data about objects (e.g., an obstacle object, a non-player object, an item, etc.) different from player objects placed in a virtual space. The other object data is data indicating the shape, the outer appearance, the position, the orientation, the movement direction, the speed, and the like of each of these objects.

The field data is data representing the entirety of the field F and includes data representing terrains. On the field, objects representing various terrains such as a road, grass, and sand, are set. The field data is data representing the kind, the shape, the outer appearance, and the like of terrains. The speeds at which the player object and other player objects travel differ depending on the kinds of terrains.

The course data is data defining a course where a competitive racing game is performed. For example, the course data includes data representing the entire route through which the player object and another player object move from a start point to a goal point. In the exemplary embodiment, a plurality of courses are prepared in advance, and course data corresponding to the respective courses are stored in advance. The course data may be stored in advance in the storage medium attached to the slot 29, or the flash memory 26, may be acquired from the server via the Internet, or may be acquired from another main body apparatus 2.

The session data is data about the game session GS in which the game system 1a is participating, and is received from the server. The session data includes an ID for identifying the game session GS.

Besides the data shown in FIG. 13, various data are stored in the game system 1.

### Game Processing

Next, game processing performed in the game system 1a will be described. FIG. 14 is a flowchart showing an example of game processing for performing an online multiplayer competitive racing game. The game processing shown in FIG. 14 is executed when an online multiplayer competitive racing game is selected by a player on a game selection screen, for example. Here, a case where, when the game systems 1c and 1d are participating in the game session GS and a competitive racing game is being performed by the player objects PC and PD, the game systems 1a and 1b join up with the game session GS, will be described as an example.

In the exemplary embodiment, the processor 21 of the main body apparatus 2 executes the game program using a memory (e.g., DRAM 27), thereby executing a process in each step shown in FIG. 14 to FIG. 19. However, in another exemplary embodiment, some of processes in the respective steps may be executed by a processor (e.g., a dedicated circuit) other than the processor 21. In a case where the game system 1 is communicable with another information processing apparatus (e.g., the server for performing the matching process, or a server different therefrom), some of the processes in the respective steps may be executed on the other information processing apparatus. The processes in the respective steps are merely examples. As long as the same result is obtained, the processing order of the steps may be changed or another process may be executed in addition to (or instead of) the process in each step.

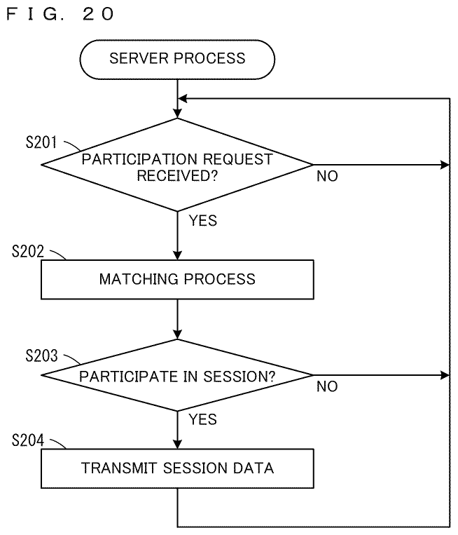

As shown in FIG. 14, first, the processor 21 transmits a participation request to participate in an online multiplayer competitive racing game, to the server on the Internet (step S10). The participation request includes information for identifying the game system 1, information about the player, and information about a condition for matching. Here, a process performed on the server will be described. FIG. 20 is a flowchart showing an example of a server process performed on the server.

As shown in FIG. 20, the server determines whether or not a participation request is received from the game system 1 (step S201). If a participation request is received (step S201: YES), the server performs a matching process for matching players who have transmitted participation requests (step S202). In the matching process, the server matches a plurality of players that satisfy a condition, based on participation requests. For example, in a case where the server has received a participation request of desiring a competition with any player, the server matches a plurality of players of which game execution records and/or levels are close to each other. In a case where the server has received a participation request of desiring a competition with a player having a predetermined relationship (e.g., a friend relationship), the server matches players who have the predetermined relationship.

Next, the server determines whether or not the players who have transmitted the participation requests should be caused to participate in (start or join up with) a game session, based on a result of the matching process (step S203). For example, if a game session that satisfies a condition has already existed, the server determines to cause the players to participate in (join up with) the game session. If such a game session that satisfies a condition does not exist, the server determines to start a new game session and cause the players to participate in the new game session. In step S203, the server may further determine whether or not the number of players to participate in the game session has reached a predetermined number.

If a result of the determination in step S203 is YES, the server transmits session data to the game systems 1 that have transmitted the participation requests (step S204). Specifically, the server assigns numbers and the like to the respective players to participate in the game session, and transmits session data including an ID for identifying the game session, the numbers, and the like. Player numbers and the like to be used during competition may be set in P2P communication between game systems after participation in the session.

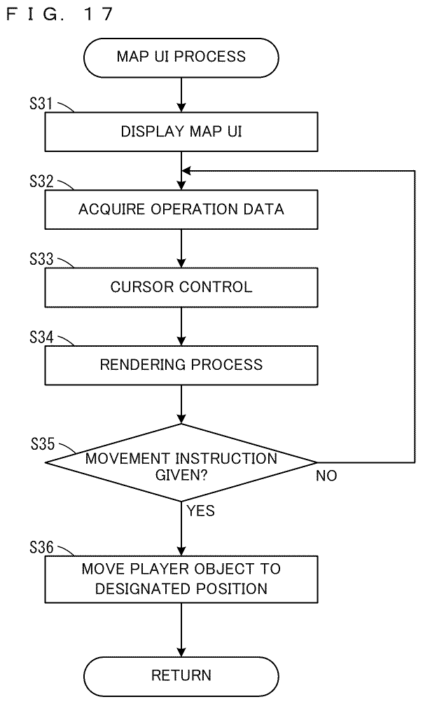

Returning to FIG. 14, after having transmitted the participation request, the processor 21 of the game system 1a starts a participation process (step S11). The participation process in step S11 is a process for participating in (starting or joining up with) a session of an online multiplayer game. The participation process is executed in the background during a period until a competitive racing game process described later is started (during execution of a first free run process and a second free run process). Hereinafter, the participation process will be described with reference to FIG. 15. FIG. 15 is a flowchart showing an example of the participation process started in step S11.

### Participation Process

As shown in FIG. 15, the processor 21 determines whether or not session data including the ID for identifying the game session GS is received from the server (step S111). If the session data is not received from the server, the processor 21 executes the process in step S111 again. In a case where the session data is not received from the server even when a predetermined time-out period (e.g., 5 minutes) has passed since transmission of the participation request, the processor 21 may determine that matching has failed, and end the participation process. In this case, the competitive racing game process described later may not be executed.

If the session data is received (step S111: YES), the processor 21 stores the session data into the memory (step S112). The session data includes the ID for identifying the game session GS. The ID is shared among the game systems 1 that participate in the same game session GS. In addition, the processor 21 stores the player number assigned to the player A.

Next, the processor 21 performs a communication establishment and information exchange process (step S113). Here, the processor 21 performs a process for establishing communication with another game system 1 participating in the game session GS, based on the ID for identifying the game session GS, received from the server. In addition, the processor 21 exchanges information needed for execution of the competitive racing game process described later, with another game system 1 with which communication has been established. For example, the processor 21 transmits position information on the player object PA, and the like, to another game system 1, and receives position information on another player object, and the like, from another game system 1.

Next, the processor 21 determines whether or not to end the participation process (step S114). For example, the processor 21 determines whether or not a race start condition for starting the competitive racing game process is satisfied. The race start condition will be described later. If a result of the determination in step S114 is NO, the processor 21 executes the process in step S113 again.

If a result of the determination in step S114 is YES, the processor 21 ends the participation process shown in FIG. 15.

Returning to FIG. 14, after the participation process is started, the processor 21 performs the first free run process (step S12). The first free run process is performed during the participation process. Specifically, the first free run process is a process to be performed before the game system 1a participates in the game session, and is a process for causing the player object PA to freely move on the field. The details of the first free run process in step S12 will be described later.

When the first free run process is ended, the processor 21 performs the second free run process (step S13). The second free run process is a process to be performed before a competitive racing game with another player is started, and is a process for causing the player object PA to freely move on the field. The second free run process is a process to be performed after the game system 1a has participated in the game session, and is a process to be performed subsequently to the first free run process. The details of the second free run process in step S13 will be described later.

When the second free run process is ended, the processor 21 executes the competitive racing game process (step S14). The competitive racing game process is a process for performing a competitive racing game between the player object PA and a plurality of other player objects. The details of the competitive racing game process in step S14 will be described later.

When the process in step S14 is ended, the processor 21 ends the process shown in FIG. 14.

### First Free Run Process

Next, the details of the first free run process in step S12 will be described. FIG. 16 is a flowchart showing an example of the first free run process in step S12.

As shown in FIG. 16, first, the processor 21 sets a virtual space and places the player object PA in the set virtual space (step S20). For example, the processor 21 may place the player object PA at a random position on the field, or may place the player object PA at a position designated by the player, on the field.

Next, the processor 21 acquires operation data (step S21). The processor 21 repeatedly acquires operation data from the controllers 3 and 4 connected to the main body apparatus 2, at predetermined time intervals (e.g., intervals of 1/200 s), and stores the operation data into the memory. The processor 21 acquires the operation data stored in the memory, in step S21.

Next, the processor 21 performs a player object control process (step S22). Here, the processor 21 updates the position, the orientation, the movement direction, the speed, and the like of the player object PA, based on the operation data. For example, in a case where a predetermined button (e.g., A button) of the controller 4 is pressed, the processor 21 moves the player object PA forward by a predetermined distance and updates the position of the player object PA. In addition, the processor 21 controls the movement direction of the player object PA in accordance with an input direction of the analog stick of the controller 3. In addition, the processor 21 determines whether or not the player object PA and an item acquisition object placed in the virtual space have contacted with each other, and if they have contacted with each other, the processor 21 causes the player object PA to acquire an item. In addition, in a case where the player object PA possesses an item and a predetermined button of the controller is pressed, the processor 21 causes the player object PA to use an item. For example, the processor 21 causes the player object PA to launch an item. In addition, the processor 21 causes the player object PA to start a predetermined action (e.g., a jump action), based on operation data.

Next, the processor 21 performs a collision determination process (step S23). Here, the processor 21 performs collision determination between objects present in the virtual space, and performs a process according to collision. Specifically, the processor 21 updates the position, the orientation, the movement direction, the speed, and the like of a moving object (e.g., a non-player object, an item, etc.) other than the player object PA. For example, the processor 21 performs a process of moving an item launched by the player object PA in step S22, in the virtual space. Then, based on the positions of the objects, the processor 21 determines whether or not the objects collide with each other. For example, the processor 21 determines whether or not the player object PA has collided with a wall object placed in the virtual space, and if the processor 21 determines that the player object PA has collided with the wall object, the processor 21 changes the movement direction of the player object PA, reduces the speed thereof, or temporarily stops the player object PA. In addition, the processor 21 determines whether or not an item launched in the virtual space has collided with another object, and if they have collided with each other, the processor 21 performs a process according to the collision.

Next, the processor 21 performs a rendering process (step S24). Here, the processor 21 generates a game image, based on a virtual camera moving while following the player object PA. Thus, a game image according to a result of the processes in steps S21 to S23 is generated and displayed on the screen of the game system 1a.

Next, the processor 21 determines whether or not to activate the map UI, based on operation data (step S25). If an operation input for activating the map UI is performed, the processor 21 makes the determination as YES in step S25.

If a result of the determination in step S25 is NO, or if a process in step S27 described later is executed, the processor 21 determines whether or not participation in a game session has been performed (step S26). For example, the processor 21 may make the determination as YES in step S26 if session data is received from the server in the participation process executed in the background.

If a result of the determination in step S26 is NO, the processor 21 executes the process in step S21 again. The processor 21 repeatedly executes the processes in steps S21 to S26 at predetermined frame time intervals (e.g., intervals of 1/60 s). Thus, a scene in which the player object PA moves on the field in accordance with an operation by the player is displayed.

If a result of the determination in step S26 is YES, the processor 21 performs a shift process (step S28). Here, based on position information on another player object received in the participation process, the processor 21 places the other player object in the virtual space, or changes the display manner of the virtual space in accordance with the environment of the virtual space set in the game session. In addition, when changing the display manner of the virtual space, the processor 21 displays a switchover image for switching the screen. For example, the processor 21 fades out the game image being displayed, over a predetermined time, and then fades in a game image of which the display manner is changed, over a predetermined time. Even if the display manner of the virtual space in the shift process in step S28 is changed, the position, the orientation, the movement direction, the speed, and the like of the player object PA are kept.

When the process in step S28 has been executed, the processor 21 ends the process shown in FIG. 16.

On the other hand, if a result of the determination in step S25 is YES, the processor 21 performs a map UI process (step S27). Hereinafter, the details of the map UI process will be described.

### Map UI Process

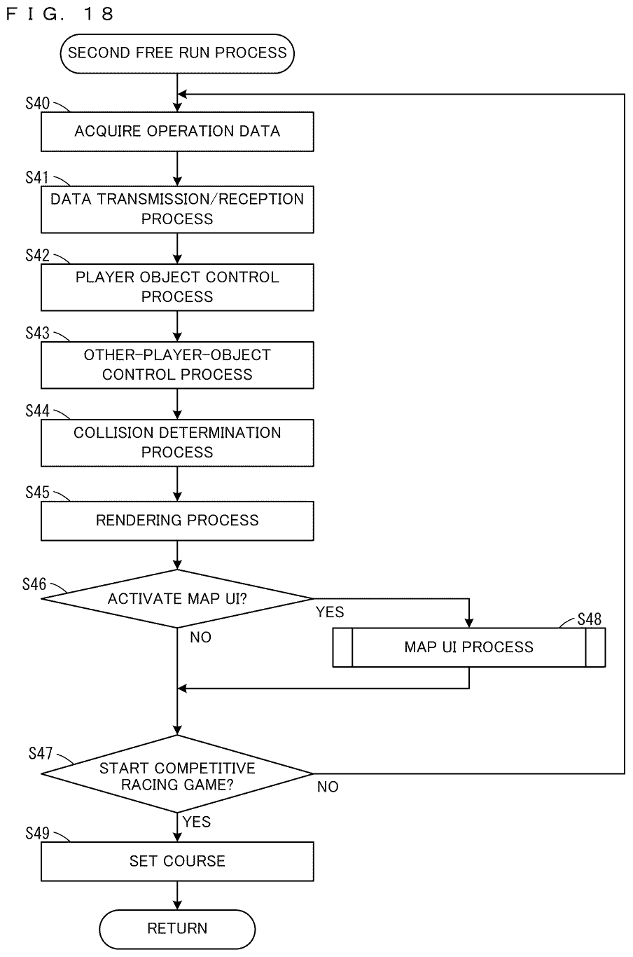

FIG. 17 is a flowchart showing an example of the map UI process in step S27. As shown in FIG. 17, first, the processor 21 displays a map UI on the screen (step S31). On the map UI, a map image indicating at least a part of the field, an icon indicating the player object PA, and the cursor CR for designating a position, are displayed.

Next, the processor 21 acquires operation data (step S32), and controls the cursor, based on the operation data (step S33). Then, the processor 21 performs a rendering process (step S34). Thus, an image including the map image, the icon indicating the player object PA, and the cursor CR, is generated and displayed.

Next, the processor 21 determines whether or not a movement instruction to a designated position has been performed (step S35). Specifically, the processor 21 determines whether or not an operation input for designating a position on the map using the cursor CR and giving an instruction for movement to the designated position has been performed.

If the movement instruction has not been performed (step S35: NO), the processor 21 executes the process in step S32. The processor 21 repeatedly executes the processes in steps S32 to S35 at predetermined frame time intervals (e.g., intervals of 1/60 s). In a case where a cancellation instruction is performed by the player while the processes in steps S32 to S35 are being repeatedly performed, the processor 21 ends the process shown in FIG. 17. In a case where a race start condition is satisfied while the processes in steps S32 to S35 are being repeatedly performed, the processor 21 ends the process shown in FIG. 17. In this case, the processor 21 performs a process in step S49 described later.

If the movement instruction has been performed (step S35: YES), the processor 21 moves the player object PA to the position designated by the cursor CR (step S36). Then, the processor 21 ends the process shown in FIG. 17.

### Second Free Run Process

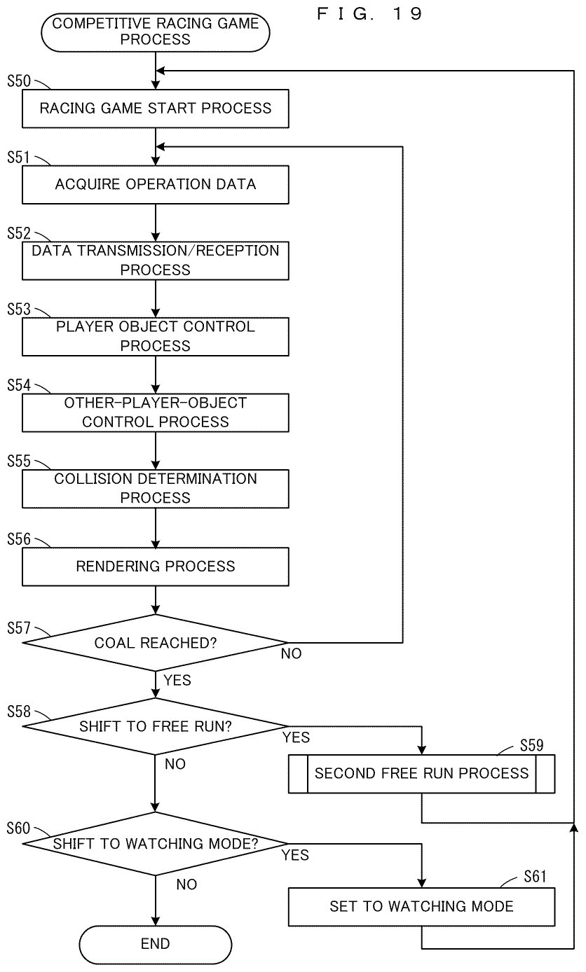

Next, the details of the second free run process in step S13 will be described. FIG. 18 is a flowchart showing an example of the second free run process in step S13.

As shown in FIG. 18, the processor 21 acquires operation data (step S40). The process in step S40 is the same as the process in step S21 described above.

Next, the processor 21 performs a data transmission/reception process (step S41). Here, the processor 21 acquires received data from another game system 1 participating in the game session, as a data reception process. For example, the processor 21 receives data about the positions, the orientations, the movement directions, the speeds, and the like of the other player objects PC and PD performing the competitive racing game, as received data, from the game systems 1c and 1d. In addition, the processor 21 receives data about the position, the orientation, the movement direction, the speed, and the like of the other player object PB performing free run, as received data, from the game system 1b. The processor 21 receives data about an item possessed by the other player object PB and data (e.g., data indicating that the item is launched, data indicating the launching direction, data indicating the launching speed, etc.) indicating that the other player object PB has used the item, as received data, from the game system 1b. In addition, the processor 21 transmits data about the position, the orientation, the movement direction, the speed, and the like of the player object PA, to the game system 1b corresponding to the other player object PB performing free run, as a data transmission process. In addition, the processor 21 transmits data about an item possessed by the player object PA and data indicating that the player object PA has used the item, to the game system 1b. The processor 21 does not transmit data (data indicating the position, the orientation, the movement direction, the speed, and that the item has been used) about the player object PA, to the game systems 1c and 1d corresponding to the other player objects PC and PD performing the competitive racing game. The processor 21 may transmit data about the player object PA to the game systems 1c and 1d.

Next, the processor 21 performs a player object control process (step S42). The player object control process in step S42 is the same as the player object control process in step S22.

Next, the processor 21 performs an other-player-object control process, based on received data (step S43). Here, the processor 21 updates the positions, the orientations, the movement directions, the speeds, and the like of the other player objects PC and PD performing the competitive racing game, based on the received data. In addition, the processor 21 updates the position, the orientation, the movement direction, the speed, and the like of the other player object PB performing free run, based on the received data. In addition, the processor 21 causes the other player object PB performing free run to use an item, based on the received data. For example, in a case where data indicating that the other player object PB has launched an item is received as the received data, the processor 21 causes the other player object PB to launch an item. In addition, the processor 21 updates the position, the orientation, the movement direction, the speed, and the like of another player object performing watching, based on the received data. In addition, the processor 21 updates the position, the orientation, the movement direction, the speed, and the like of another player object performing capturing, based on the received data.

Next, the processor 21 performs a collision determination process (step S44). Here, the processor 21 performs collision determination between objects present in the virtual space, and performs a process according to collision. The collision determination process in step S44 is basically the same as the collision determination process in step S23, but is different in that, in step S44, the player object PA interacts with another player object performing free run. Specifically, the processor 21 updates the position, the orientation, the movement direction, the speed, and the like of a moving object (e.g., a non-player object, an item, etc.) other than the player object PA and the other player object. For example, in a case where the player object PA has launched an item in step S42, the processor 21 performs a process of moving the item. In addition, in a case where the player object PB has launched an item in step S43, the processor 21 performs a process of moving the item. Then, the processor 21 determines whether or not objects collide with each other, based on the position of each object. For example, the processor 21 performs collision determination between the player object PA, and the other player object PB performing free run, and if the processor 21 determines that they collide with each other, the processor 21 performs a process according to the collision. For example, as the process according to the collision, the processor 21 causes the player objects PA and PB to be overturned, reduced in speed, or temporarily stopped. In addition, the processor 21 performs collision determination between an item launched by the other player object PB, and the player object PA, and if the processor 21 determines that they collide with each other, the processor 21 causes the player object PA to perform a behavior according to collision with the item. For example, as the process according to the collision with the item, the processor 21 causes the player object PA to be overturned, reduced in speed, or temporarily stopped. In addition, the processor 21 performs collision determination between an item launched by the player object PA, and the other player object PB, and if the processor 21 determines that they collide with each other, the processor 21 causes the other player object PB to perform a behavior according to the collision with the item. On the other hand, the processor 21 does not perform collision determination between the player object PA, and the other player objects PC and PD performing the competitive racing game. In addition, the processor 21 does not perform collision determination between the player object PA, and another player object performing watching. In addition, the processor 21 performs collision determination between the player object PA, and another player object performing capturing.

Next, the processor 21 performs a rendering process (step S45). The processor 21 generates a game image, based on a virtual camera set in back of the player object PA. Here, the processor 21 generates the game image such that the other player objects PC and PD performing the competitive racing game are set to be translucent. In addition, the processor 21 generates the game image such that the player object PA and the other player object PB performing free run are set to be opaque. In addition, the processor 21 generates a game image such that another player object performing watching is set to be translucent. In addition, the processor 21 generates the game image such that another player object performing capturing is set to be opaque. In addition, the processor 21 sets a UI indication according to the state of another player object. For example, the processor 21 sets a text “RACING” as a UI indication, near the other player objects PC and PD performing the competitive racing game. In addition, the processor 21 sets a text “WATCHING” as a UI indication, near another player object performing watching. In addition, the processor 21 sets a text “CAPTURING” as a UI indication, near another player object performing capturing.

Next, the processor 21 determines whether or not to activate the map UI, based on operation data (step S46). If the processor 21 determines to activate the map UI (step S46: YES), the processor 21 performs a map UI process (step S48). The processes in steps S46 and S48 are the same as the processes in steps S25 and S27, and therefore the detailed description thereof is omitted. In the map UI process in step S48, icons respectively indicating the other player objects PB to PD participating in the game session are displayed in addition to an icon of the player object PA, on the map image.

If the processor 21 determines not to activate the map UI (step S46: NO), the processor 21 determines whether or not to start a competitive racing game (step S47). For example, the processor 21 determines whether or not a race start condition for starting a competitive racing game is satisfied. The race start condition includes that the competitive racing game being performed by the players C and D is ended, for example. In a case where a new game session is started, the race start condition may be that a predetermined time has passed since reception of session data, for example. The race start condition may include that the number of participants in a multiplayer session reaches a predetermined number (e.g., an upper limit number or a predetermined value smaller than an upper limit value). The race start condition may be that information indicating start of a racing game is received from the server or another game system 1.

If the processor 21 determines not to start a competitive racing game (step S47:
NO), the processor 21 executes the process in step S40 again. The processor 21 repeatedly executes the processes in steps S40 to S47 at predetermined frame time intervals (e.g., intervals of 1/60 s). Thus, a scene in which the player object PA freely moves on the field based on an operation by the player A and the player objects PB to PD move, is displayed.

While the processes in steps S40 to S47 are repeatedly performed, the player may be allowed to give an instruction to exit the game session in which the player is participating. If an instruction to exit the game session is given by the player, the processor 21 may end the second free run process shown in FIG. 18 and return to the first free run process. In this case, the position of the player object PA may be kept between before and after the game session is exited. In addition, while the player object is performing free run after returning to the first free run process, a participation request may be allowed to be transmitted to the server, based on an operation input by the player, so that the player object can participate in another game session or join up with the same game session again.

On the other hand, if the processor 21 determines to start a competitive racing game (step S47: YES), the processor 21 sets a course for the next competitive racing game (step S49). For example, the processor 21 determines a course for the next competitive racing game, based on selection operations by the players A to D to participate in the next competitive racing game. The server may determine the next course. As a course for the next competitive racing game, a course different from the course of the last competitive racing game just performed by the players C and D may be determined. After setting the course for the next competitive racing game, the processor 21 ends the process shown in FIG. 18 and returns the process to FIG. 14. Then, the processor 21 executes a competitive racing game process using the set course.

### Competitive Racing Game Process

Next, the details of the competitive racing game process will be described. FIG. 19 is a flowchart showing an example of the competitive racing game process in step S14.

As shown in FIG. 19, the processor 21 performs a racing game start process (step S50). Specifically, the processor 21 places a plurality of player objects to participate in the competitive racing game, at a start position on the set course. Here, the processor 21 places the player objects PA to PD at the start position. Then, the processor 21 starts the competitive racing game after a predetermined time has passed. During the competitive racing game, the player objects PA to PD participating in the competitive racing game are placed in a virtual space, and another player object that is performing free run, capturing, or watching is not placed in the virtual space.

When the competitive racing game is started, the processor 21 acquires operation data (step S51). The process in step S51 is the same as the process in step S21.

Next, the processor 21 performs a data transmission/reception process (step S52). Here, as the data reception process, the processor 21 acquires received data sent from the game systems 1b to 1d corresponding to the other player objects PB to PD performing the competitive racing game. Specifically, the game system 1a receives data about items possessed by the other player objects PB to PD, and data indicating that the other player objects PB to PD have used the items (e.g., data indicating that an item is launched, data indicating the launching direction, data indicating the launching speed, etc.), in addition to data indicating the positions, the orientations, the movement directions, the speeds, and the like of the other player objects PB to PD, as the received data. In addition, as the data transmission process, the processor 21 transmits similar data (data indicating the position, the orientation, the movement direction, the speed, and that an item is used, etc.) regarding the player object PA, to the game systems 1b to 1d.

Next, the processor 21 performs a player object control process (step S53). The player object control process in step S53 is the same as the player object control process in step S42.

Next, the processor 21 performs an other-player-object control process (step S54). Here, the processor 21 updates the positions, the orientations, the movement directions, the speeds, and the like of the other player objects PB to PD performing the competitive racing game, based on received data. In addition, the processor 21 causes the other player objects PB to PD to use items, based on the received data. For example, in a case where data indicating that the other player object PB has launched an item is received as the received data, the processor 21 causes the other player object PB to launch the item.

Next, the processor 21 performs a collision determination process (step S55). Here, the processor 21 performs collision determination between objects present in the virtual space and performs a process according to collision. Specifically, the processor 21 updates the position, the orientation, the movement direction, the speed, and the like of a moving object (e.g., a non-player object, an item, etc.) other than the player objects PA to PD. For example, in a case where any of the player objects PA to PD has launched an item, the processor 21 performs a process of moving the item. Then, the processor 21 performs collision determination with another object, for each of the player objects PA to PD. For example, the processor 21 performs collision determination between the player object PA and each of the other player objects PB to PD, and if the processor 21 determines that the player object PA collides with any of the other player objects PB to PD, the processor 21 performs a process according to collision. In addition, the processor 21 performs collision determination between the player object PA and an item launched in the virtual space by any of the other player objects PB to PD, and if the processor 21 determines that the player object PA collides with the item, the processor 21 causes the player object PA to perform a behavior according to the collision with the item.

Next, the processor 21 performs a rendering process (step S56). The processor 21 generates a game image, based on a virtual camera set in back of the player object PA. Here, the processor 21 generates the game image such that the other player objects PB to PD performing the competitive racing game are set to be opaque (in a normal manner).

Next, the processor 21 determines whether or not the player object PA has reached a goal (step S57).

If the player object PA has not reached the goal (step S57: NO), the processor 21 executes the process in step S51 again. The processor 21 repeatedly executes the processes in steps S51 to S57 at predetermined frame time intervals (e.g., intervals of 1/60 s). Thus, the competitive racing game progresses.

If the player object PA has reached the goal (step S57: YES), the processor 21 determines whether or not to shift the player object PA to free run (step S58). For example, the processor 21 may determine whether or not to shift the player object PA to free run, based on an operation input by the player. In a case where there is a next race, the player object PA may be always shifted to free run after reaching the goal, except for a case where an instruction to exit the race and quit is given.

If the processor 21 determines to shift the player object PA to free run (step S58: YES), the processor 21 performs a second free run process (step S59). The second free run process in step S59 is as described with reference to FIG. 18. When the second free run process is ended, a next course is set. When the second free run process is ended, the processor 21 executes the process in step S50 again, to start a next competitive racing game. If a result of the determination in step S58 is YES, the processor 21 may perform the first free run process instead of the second free run process, based on an operation input by the player. That is, after the competitive racing game is ended, the player may be allowed to exit the game session and perform free run alone.

After step S57, the second free run process in step S59 may be performed without performing the determination in step S58. Before the player object PA has reached the goal, based on a predetermined operation input by the player, the competitive racing game may be ended halfway and the second free run process in step S59 (or first free run process) may be performed.

If the processor 21 determines not to shift the player object PA to free run (step S58: NO), the processor 21 determines whether or not to shift to a watching mode (step S60). For example, the processor 21 determines whether or not to shift to the watching mode, based on an operation input by the player. Shift to the watching mode may be performed in a case of, for example, retiring a competition halfway, instead of or in addition to when reaching the goal. For example, in a racing mode in which a participant whose ranking position is lower than a reference when passing through a check point retires, whether or not to shift to the watching mode may be determined for the retired participant, based on an operation input.

If the processor 21 determines to shift to the watching mode (step S60: YES), the processor 21 sets the mode to the watching mode (step S61). Then, the processor 21 executes the process in step S50 again to start a next racing game.

If the processor 21 determines not to shift to the watching mode (step S60: NO), the processor 21 ends the process shown in FIG. 19.

As described above, in the exemplary embodiment, the second free run process is performed in a period until the competitive racing game process is performed. In the second free run process, the game system 1 performs movement control for the player object corresponding to the own system, on the field, based on an operation input by the player, and also, acquires position information on another player object participating in the game session and controls the other player object on the field. Thus, in a period before a competitive racing game is started, the player can move the player object together with another player object on the field where a competitive racing game is performed. In addition, while the player object is participating in a game session and is moved on the field together with another player object, if a race start condition is satisfied, a competitive racing game using the player object and the other player object can be started. Thus, competitive racing games can be performed seamlessly.

In the exemplary embodiment, during a period until a predetermined number of players gather so that a game start condition is satisfied, the second free run process is continuously performed in each game system 1. Thus, during a certain period, each player can move the player object corresponding to the player him/herself, on the field, together with another player object.

In the exemplary embodiment, while the player object is performing free run, the participation process for participating in the game session is performed, and also after participating in the game session, the player object continues free run. Thus, the player object can participate in the game session seamlessly during free run. In addition, while the player object is participating in the game session and performing free run, the player object can exit the game session and continue free run.

In the exemplary embodiment, a player object performing free run and a player object performing a competitive racing game are displayed in display manners different from each other. Thus, the player can easily recognize whether another player object is performing a competitive racing game or free run.

In the exemplary embodiment, a player object performing free run and another player object performing a competitive racing game do not interact with each other. A player object performing free run and another player object performing free run interact with each other. Thus, the player can watch the competitive racing game being executed, without disturbing the competitive racing game, and meanwhile, can enjoy a game with another player also during free run.

In the exemplary embodiment, the player can activate the map UI during free run and can move the player object using the map UI. On the map UI, a UI indicating another player object is displayed. Thus, even in a case where a game is performed on a vast field, the player object can be moved to a desired position, and for example, the player object can be moved to a place where the other player object is present.

### Modifications

While the exemplary embodiment has been described above, the above exemplary embodiment is merely an example, and the following modifications may be applied, for example.

For example, in the above exemplary embodiment, before a competitive racing game is started, the first free run process is performed and then the second free run process is performed. In another exemplary embodiment, before a competitive racing game is started, the second free run process may be performed without the first free run process being performed. That is, after the player object has participated in a game session, free run may be started, and then, when a race start condition is satisfied, a competitive racing game may be started.

In the above exemplary embodiment, while the player object is performing free run, regarding another player object performing free run, information about an item of the other player object is acquired in addition to information (position information, speed information, etc.) about movement of the other player object. The information about the item of the other player object includes information on the item possessed by the other player object and information on the item used by the other player object (the position, the movement direction, the speed, and the like of the launched item). On the other hand, while the player object is performing free run, regarding another player object performing a competitive racing game, only information about movement of the other player object is acquired and information about the item of the other player object is not acquired.

In another exemplary embodiment, while the player object is performing free run, regarding another player object performing a competitive racing game, information about an item of the other player object may be acquired in addition to information about movement of the other player object.

In another exemplary embodiment, while the player object is performing free run, regarding another player object performing free run, only information about movement of the other player object may be acquired and information about the item of the other player object may not be acquired.

In the above exemplary embodiment, the player object performing free run interacts with another player object performing free run. In another exemplary embodiment, the player object performing free run may not interact with another player object performing free run.

In the above exemplary embodiment, the game systems 1 participating in a game session establish communication with each other, and exchange information (the position, the orientation, the speed, etc.) about each player object directly between the game systems 1. That is, free run and a competitive racing game with other players are performed based on P2P communication between the game systems 1. In another exemplary embodiment, the game systems 1 participating in a game session may exchange information about player objects via the server.

In the above exemplary embodiment, the game system 1 performs movement control for the player object. In another exemplary embodiment, the server may perform movement control for player objects. That is, in the server, movement control for each player object may be performed, position information on each player object may be transmitted to the game systems 1, and the player objects may be displayed on each game system 1.

The above processes may be executed in another arbitrary information processing apparatus or information processing system, instead of the game system 1. The information processing system may be composed of a plurality of apparatuses, and the plurality of apparatuses may be connected via a network (e.g., LAN or the Internet).

The configurations according to the above exemplary embodiment and the modifications thereof may be combined together as desired as long as the configurations do not contradict each other. The above is merely an example of the exemplary embodiment, and various modifications and variations other than the above may be made.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors to execute game processing comprising, regarding an online multiplayer competitive racing game:
in a period until a race start condition is satisfied,
performing a session participation process including starting or joining up with a multiplayer session, based on communication,
performing movement control for a player object on a field in a virtual space, based on an operation input,
transmitting position information on the player object, and
performing, on the field, movement control for another player object included in a multiplayer session being participated in, based on position information on the other player which is acquired based on communication;
in a case where the race start condition is satisfied, starting the competitive racing game by players included in the multiplayer session; and
during the competitive racing game,
in a course corresponding to the competitive racing game, among a plurality of courses set at respective places on the field,
performing movement control for the player object, based on an operation input,
transmitting position information on the player object, and
controlling another player included in the multiplayer session being participated in, based on position information on the other player object which is acquired based on communication,
thus performing the competitive racing game.

2. The one or more non-transitory computer-readable media according to claim 1, wherein
the race start condition includes that a number of participants in the multiplayer session reaches a predetermined number,
the game processing further comprising, in the period until the race start condition is satisfied,
performing movement control for the player object and the other player object, and
continuously performing the session participation process until the number of participants in the multiplayer session reaches the predetermined number.

3. The one or more non-transitory computer-readable media according to claim 1, wherein
the multiplayer session is a session that allows joining up with a session including the other player performing a race, through the session participation process, and
the race start condition includes at least that the other player participating in the multiplayer session is not performing a race.

4. The one or more non-transitory computer-readable media according to claim 3, the game processing further comprising, in the period until the race start condition is satisfied,
setting, for the other player object performing a race, a display manner different from that for the other player object not performing a race.

5. The one or more non-transitory computer-readable media according to claim 4, wherein
the different display manner is such a display manner that transparency is increased.

6. The one or more non-transitory computer-readable media according to claim 4, wherein
the different display manner is such a display manner that a UI indicating a state of performing a race is added,
the game processing further comprising, in the period until the race start condition is satisfied,
setting, for the other player object not performing the race, a display manner in which a UI indicating a predetermined state is added, in a case where the other player object is in the predetermined state.

7. The one or more non-transitory computer-readable media according to claim 3, the game processing further comprising, in the period until the race start condition is satisfied,
without performing collision determination between the other player object performing a race and the player object,
performing collision determination between the other player object not performing a race and the player object, and performing a collision process based on the collision determination.

8. The one or more non-transitory computer-readable media according to claim 1, the game processing further comprising:
rendering the field in a display manner based on an environment being set, among a plurality of kinds of environments to be set for the virtual space; and
in a case of having participating in the multiplayer session through the session participation process, changing the environment of the virtual space to the environment set in the multiplayer session participated in.

9. The one or more non-transitory computer-readable media according to claim 1, the game processing further comprising:
in accordance with an instruction based on an operation input, presenting a map UI representing a map on the field and including at least a UI indicating a position of the player object on the field, a UI indicating a position of the other player object on the field, and movement destination UIs indicating at least a plurality of movement destination points set on the field; and
in a case where, on the map UI, one of the movement destination UIs is designated based on an operation input, changing a position of the player object to a position on the field corresponding to the movement destination point, and restarting movement control from the changed position.

10. An information processing system comprising:
one or more processors; and
one or more non-transitory computer-readable media having stored therein instructions that, when executed, cause the one or more processors to execute game processing comprising:
in a period until a race start condition is satisfied,
performing a session participation process including starting or joining up with a multiplayer session, based on communication,
performing movement control for a player object on a field in a virtual space, based on an operation input,
transmitting position information on the player object, and
performing, on the field, movement control for another player object included in a multiplayer session being participated in, based on position information on the other player which is acquired based on communication;
in a case where the race start condition is satisfied, starting the competitive racing game by players included in the multiplayer session; and
during the competitive racing game,
in a course corresponding to the competitive racing game, among a plurality of courses set at respective places on the field,
performing movement control for the player object, based on an operation input,
transmitting position information on the player object, and
controlling another player included in the multiplayer session being participated in, based on position information on the other player object which is acquired based on communication,
thus performing the competitive racing game.

11. The information processing system according to claim 10, wherein
the race start condition includes that a number of participants in the multiplayer session reaches a predetermined number,
the processor being configured to further, in the period until the race start condition is satisfied,
perform movement control for the player object and the other player object, and
continuously perform the session participation process until the number of participants in the multiplayer session reaches the predetermined number.

12. The information processing system according to claim 10, wherein
the multiplayer session is a session that allows joining up with a session including the other player performing a race, through the session participation process, and
the race start condition includes at least that the other player participating in the multiplayer session is not performing a race.

13. The information processing system according to claim 12, the processor being configured to further, in the period until the race start condition is satisfied,
set, for the other player object performing a race, a display manner different from that for the other player object not performing a race.

14. The information processing system according to claim 13, wherein
the different display manner is such a display manner that transparency is increased.

15. The information processing system according to claim 13, wherein
the different display manner is such a display manner that a UI indicating a state of performing a race is added,
the processor being configured to further, in the period until the race start condition is satisfied,
set, for the other player object not performing the race, a display manner in which a UI indicating a predetermined state is added, in a case where the other player object is in the predetermined state.

16. The information processing system according to claim 12, the processor being configured to further, in the period until the race start condition is satisfied,
without performing collision determination between the other player object performing a race and the player object,
perform collision determination between the other player object not performing a race and the player object, and perform a collision process based on the collision determination.

17. The information processing system according to claim 10, the processor being configured to further:
render the field in a display manner based on an environment being set, among a plurality of kinds of environments to be set for the virtual space; and
in a case of having participating in the multiplayer session through the session participation process, change the environment of the virtual space to the environment set in the multiplayer session participated in.

18. The information processing system according to claim 10, the processor being configured to further:
in accordance with an instruction based on an operation input, present a map UI representing a map on the field and including at least a UI indicating a position of the player object on the field, a UI indicating a position of the other player object on the field, and movement destination UIs indicating at least a plurality of movement destination points set on the field; and
in a case where, on the map UI, one of the movement destination UIs is designated based on an operation input, change a position of the player object to a position on the field corresponding to the movement destination point, and restarting movement control from the changed position.

19. A computer-implemented method comprising, regarding an online multiplayer competitive racing game:
in a period until a race start condition is satisfied,
performing a session participation process including starting or joining up with a multiplayer session, based on communication,
performing movement control for a player object on a field in a virtual space, based on an operation input,
transmitting position information on the player object, and
performing, on the field, movement control for another player object included in a multiplayer session being participated in, based on position information on the other player which is acquired based on communication;
in a case where the race start condition is satisfied, starting the competitive racing game by players included in the multiplayer session; and
during the competitive racing game,
in a course corresponding to the competitive racing game, among a plurality of courses set at respective places on the field,
performing movement control for the player object, based on an operation input,
transmitting position information on the player object, and
controlling another player included in the multiplayer session being participated in, based on position information on the other player object which is acquired based on communication,
thus performing the competitive racing game.

20. The computer-implemented method according to claim 19, wherein
the race start condition includes that a number of participants in the multiplayer session reaches a predetermined number,
the computer-implemented method further comprising, in the period until the race start condition is satisfied,
performing movement control for the player object and the other player object, and
continuously performing the session participation process until the number of participants in the multiplayer session reaches the predetermined number.

21. The computer-implemented method according to claim 19, wherein
the multiplayer session is a session that allows joining up with a session including the other player performing a race, through the session participation process, and
the race start condition includes at least that the other player participating in the multiplayer session is not performing a race.

22. The computer-implemented method according to claim 21, further comprising, in the period until the race start condition is satisfied,
setting, for the other player object performing a race, a display manner different from that for the other player object not performing a race.

23. The computer-implemented method according to claim 22, wherein
the different display manner is such a display manner that transparency is increased.

24. The computer-implemented method according to claim 22, wherein
the different display manner is such a display manner that a UI indicating a state of performing a race is added,
the computer-implemented method further comprising, in the period until the race start condition is satisfied,
setting, for the other player object not performing the race, a display manner in which a UI indicating a predetermined state is added, in a case where the other player object is in the predetermined state.

25. The computer-implemented method according to claim 21, further comprising, in the period until the race start condition is satisfied,
without performing collision determination between the other player object performing a race and the player object,
performing collision determination between the other player object not performing a race and the player object, and performing a collision process based on the collision determination.

26. The computer-implemented method according to claim 19, further comprising:
rendering the field in a display manner based on an environment being set, among a plurality of kinds of environments to be set for the virtual space; and
in a case of having participating in the multiplayer session through the session participation process, changing the environment of the virtual space to the environment set in the multiplayer session participated in.

27. The computer-implemented method according to claim 19, further comprising:
in accordance with an instruction based on an operation input, presenting a map UI representing a map on the field and including at least a UI indicating a position of the player object on the field, a UI indicating a position of the other player object on the field, and movement destination UIs indicating at least a plurality of movement destination points set on the field; and
in a case where, on the map UI, one of the movement destination UIs is designated based on an operation input, changing a position of the player object to a position on the field corresponding to the movement destination point, and restarting movement control from the changed position.
